(19) United States
(12) Patent Application Publication
(10) Pub. No.: US 2017/0076185 A1
(43) Pub. Date: Mar. 16, 2017

(54) PRINTING APPARATUS AND METHOD FOR CONTROLLING PRINTING APPARATUS

(71) Applicant: CANON KABUSHIKI KAISHA, Tokyo (JP)

(72) Inventor: Yoshitake Mizuno, Toride-shi (JP)

(21) Appl. No.: 15/261,625

(22) Filed: Sep. 9, 2016

(30) Foreign Application Priority Data
Sep. 15, 2015 (JP) 2015-182153

(51) Int. Cl. G06K 15/02; H04N 1/32; H04N 1/60

(52) U.S. Cl. CPC G06K 15/1848; G06K 15/188; H04N 1/60; H04N 1/32101; G06K 15/1889; H04N 2201/0094

(57) ABSTRACT

A printing apparatus capable of arranging and printing a plurality of duplicates of an input image on a same side of a single sheet, includes a printing unit configured to print an image on a sheet using a color material, and a controller configured to act as: a changing unit configured to change, to a white image, a portion of an image that is to be printed by the printing unit, based on a region provided at each edge of the sheet and to which the color material is not to be applied, and a control unit configured to control the changing unit to change, to a white pixel, a neighborhood of a border between the plurality of duplicates arranged on the same side of the single sheet, based on a size of the region to which the color material is not to be applied.

### BACKGROUND OF THE INVENTION

Field of the Invention

The present invention relates to a printing apparatus capable of arranging and printing a plurality of images on a same side of a single sheet so that a plurality print products can be acquired by cutting the printed sheet.

Description of the Related Art

Conventionally, there have been known printing apparatuses capable of arranging and printing duplicates of an input image on a same side of a single sheet to reduce the printing time and the number of sheets used for the printing. Japanese Patent Application Laid-Open No. 2005-260514 discusses a printing apparatus with which a user can obtain a plurality of print products by cutting a printed sheet at lower costs than a case of using a plurality of sheets each for one print product.

Further, Japanese Patent Application Laid-Open No. 2003-237125 discusses a printing apparatus for printing an image onto a sheet, and in the printing apparatus, edge portions (i.e., margin) of an image to be printed on a sheet is deleted. This processing makes it possible to prevent an occurrence of sheet contamination by a color material (e.g., toner and ink) running off the sheet, and an occurrence of paper jam by a sheet winding around a roller.

In the printing apparatus discussed in Japanese Patent Application Laid-Open No. 2003-237125, a region (hereinafter referred to as a “print-prohibited region”) to which no color material is to be applied is set for each edge of a sheet. Thus, in a case of printing an image having the same size as the size of the sheet, a region of each edge of the image is deleted and then the image is printed.

In this case, the deletion of a region of each edge of an image that is to be printed may be performed also in a case where a plurality of images is arranged and printed on one side of a single sheet. When the printing is performed based on a print image including a plurality of images arranged on one side of a single sheet, if an image in a region of each edge portion is deleted from the print image, a printing result as illustrated in FIG. 13 is obtained. FIG. 13 illustrates an example case where a print image with an image in a print-prohibited region deleted is printed on a sheet conveyed with its short sides being perpendicular to a sheet conveyance direction. As illustrated by a printing result 1301, an image in the neighborhood of a cutting position along which the sheet is to be cut is not deleted. Accordingly, when a user cuts the printed sheet, prints 1302a and 1302b are obtained without deleting an image of a neighborhood region of one of the long sides of each cut sheet. As described above, in the case of arranging and printing the plurality of same images onto one side of a single sheet, if only an image of each edge of the sheet before cutting is simply deleted, the resulting cut print products may have different appearances with each other.

### SUMMARY OF THE INVENTION

According to an aspect of the present invention, a printing apparatus capable of arranging and printing a plurality of duplicates of an input image on a same side of a single sheet, includes a printing unit configured to print an image on a sheet using a color material, and a controller configured to act as: a changing unit configured to change, to a white image, a portion of an image that is to be printed by the printing unit, based on a region provided at each edge of the sheet and to which the color material is not to be applied; and a control unit configured to control the changing unit to change, to a white pixel, a neighborhood of a border between the plurality of duplicates arranged on the same side of the single sheet, based on a size of the region to which the color material is not to be applied.

According to an aspect of the disclosure, in the case of arranging and printing duplicates of an input image on one side of a single sheet, an image in a neighborhood region of a cutting position is deleted based on a print-prohibited region so that cut print products will have the same appearance.

Further features of the present invention will become apparent from the following description of exemplary embodiments with reference to the attached drawings.

### BRIEF DESCRIPTION OF THE DRAWINGS

FIG. 1 is a block diagram illustrating a hardware configuration of a printing apparatus according to an exemplary embodiment.

FIG. 2 is a cross sectional view illustrating a printing apparatus according to an exemplary embodiment.

FIG. 3 illustrates an example of an operation screen displayed on a panel of an operation unit according to an exemplary embodiment.

FIG. 4 illustrates a frame deletion function according to an exemplary embodiment.

FIGS. 5A, 5B, and 5C each illustrate an image deletion based on a print-prohibited region according to an exemplary embodiment.

FIG. 6 illustrates an example of an operation screen displayed on a panel of an operation unit according to an exemplary embodiment.

FIG. 7 illustrates an image deletion with appearances of cut print products taken into consideration according to an exemplary embodiment.

FIG. 8 is a flow chart illustrating a control performed by a printing apparatus according to an exemplary embodiment.

FIG. 9 is a flow chart illustrating a control performed by a printing apparatus according to an exemplary embodiment.

FIG. 10 illustrates an image deletion with appearances of cut print products taken into consideration according to an exemplary embodiment.

FIG. 11 illustrates an image deletion with appearances of cut print products taken into consideration according to an exemplary embodiment.

FIGS. 12A and 12B each illustrate a direction in which a sheet is conveyed according to an exemplary embodiment.

FIG. 13 illustrates an image deletion based on a print-prohibited region.

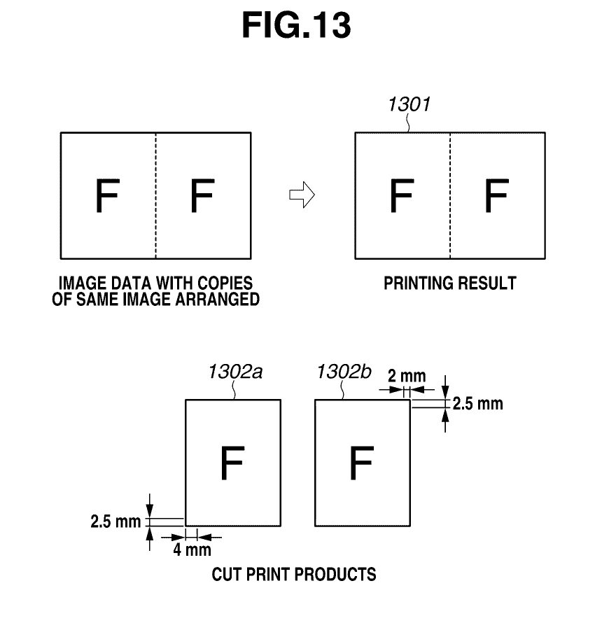

### DESCRIPTION OF THE EMBODIMENTS

Various exemplary embodiments of the invention will be described in detail below with reference to the drawings. The exemplary embodiments described below are not intended to limit the scope of the claimed invention, and not all combinations of features described in the exemplary embodiments are always essential to a technical solution of the invention.

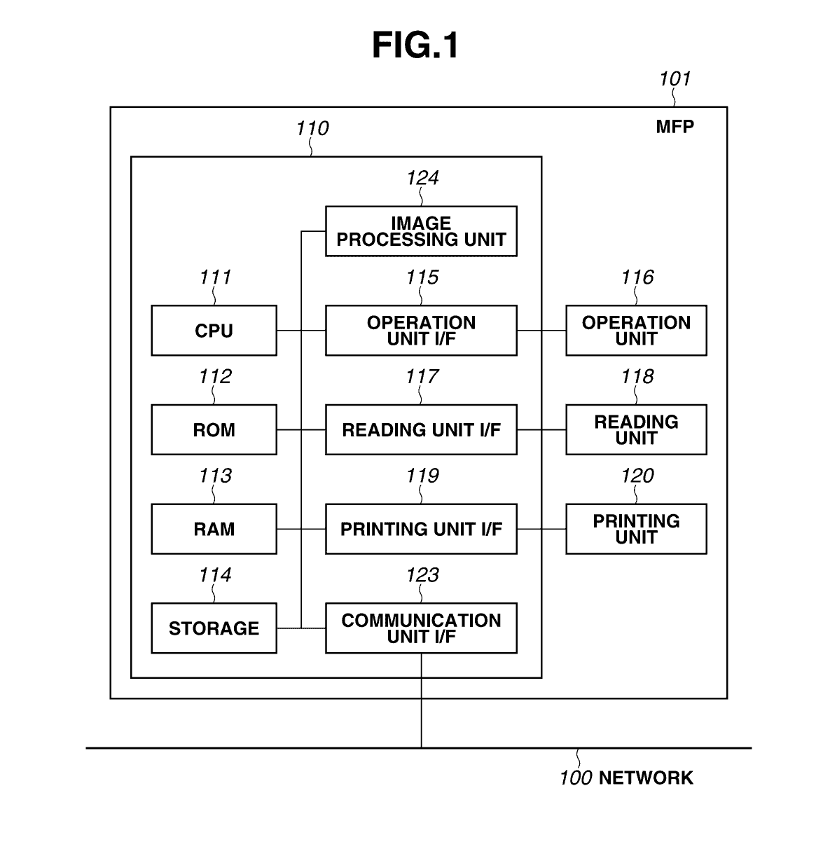

FIG. 1 is a block diagram illustrating a hardware configuration of a printing apparatus according to a first exemplary embodiment of the present invention. In the present exemplary embodiment, a multi-function peripheral (MFP) 101 will be described as an example of the printing apparatus.

The MFP 101 has a reading function to read an image on a sheet and a printing function to print an image on a sheet. Further, the MFP 101 has a file transmitting function to transmit an image to an external apparatus.

While the MFP 101 is described as an example of the printing apparatus in the present exemplary embodiment, the printing apparatus is not limited thereto. For example, the printing apparatus may be a printing apparatus that does not have the reading function, such as a single function peripheral (SFP).

A control unit (controller) 110 including a central processing unit (CPU) 111 controls operations of the entire MFP 101. The CPU 111 reads control programs stored in a read only memory (ROM) 112 or storage 114 to perform various types of control such as reading control, printing control. The ROM 112 stores control programs executable by the CPU 111. A random access memory (RAM) 113 is a main storage memory of the CPU 111 and is used as a work area or a temporary storage area into which various types of control programs are loaded. The storage 114 stores print data, image data, various types of programs, and various types of settings information. While the storage 114 is an auxiliary storage device such as a hard disk drive (HDD) in the present exemplary embodiment, a non-volatile memory such as a solid state drive (SSD) may be used in place of the HDD.

While one CPU 111 executes processing illustrated in a flow chart described below by use of one memory (RAM 113) in the MFP 101 according to the present exemplary embodiment, any other configuration may be employed. For example, a plurality of CPUs, RAMs, ROMs, and storages may execute processing illustrated in a flow chart described below in a cooperating manner. Further, a hardware circuit such as an application specific integrated circuit (ASIC), a field-programmable gate array (FPGA) may be used to execute a part of the processing.

An operation unit interface (I/F) 115 connects an operation unit 116 and the control unit 110 with each other. The operation unit 116 includes a liquid crystal display unit having a touch panel function, various types of hard keys. The operation unit 116 functions as a display unit for displaying information and a reception unit for receiving user instructions.

A reading unit I/F 117 connects a reading unit 118 and the control unit 110 with each other. The reading unit 118 reads an image on a document to generate image data. The generated image data corresponds to an input image. The generated image data is stored in the storage 114 or the RAM 113. Image data generated by the reading unit 118 is transmitted to an external apparatus or used to print the image onto a sheet.

A printing unit I/F 119 connects a printing unit 120 and the control unit 110 with each other. Image data generated by the reading unit 118 is transferred from the control unit 110 to the printing unit 120 via the printing unit I/F 119. The printing unit 120 receives via the control unit 110 a control command and image data to be printed, and prints an image onto a sheet based on the image data.

Further, the control unit 110 is connected to a network 100 via a communication unit I/F 123. The communication unit I/F 123 transmits image data and information to an external apparatus on the network 100 and receives print data and information from an information processing apparatus on the network 100.

An image processing unit 124 performs image processing on image data read by the reading unit 118 and image data that is to be transferred to the printing unit 120. The image processing unit 124 reads image data stored in the storage 114 or the RAM 113 to generate image data in which the read image data is repeatedly arranged. Further, the image processing unit 124 can replace pixels of a portion (e.g., an edge of an image) of an image region with white pixels.

While the case where the image processing unit 124 performs image processing on image data stored in the storage 114 or the RAM 113 is described in the present exemplary embodiment, it is not limited thereto. Image data generated by the reading unit 118 may be processed by an ASIC (not illustrated) for image processing included in the reading unit 118. Further, image data transferred from the storage 114 or the RAM 113 may be processed by an ASIC (not illustrated) for image processing included in the printing unit 120. Further, the CPU 111 may execute a program for executing image processing to perform image processing on image data. Further, image processing may be performed by a combination of any of them.

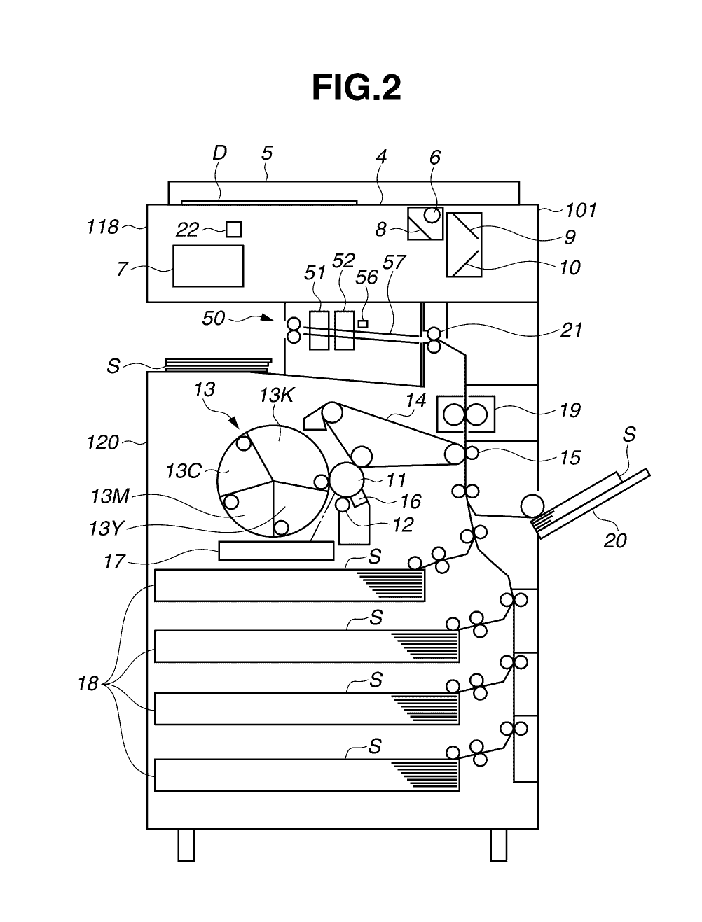

The reading unit 118 and the printing unit 120 will be described. FIG. 2 is a cross sectional view of the MFP 101. The MFP 101 mainly includes the reading unit 118, which reads a document to generate image data, and the printing unit 120, which prints an image onto a sheet (e.g., normal sheet, thick sheet, transparent film) based on the image data. An upper part of the reading unit 118 includes a platen glass 4 including a transparent glass plate. A document D set in a predetermined position on the platen glass 4 with a reading target image facing down is pressed and fixed by a document pressing plate 5. Below the platen glass 4 are provided a lamp 6, which emits light to the document D, and an optical system member that includes reflecting mirrors 8, 9, and 10 and guides reflection light to an image processing unit 7. The lamp 6 and the reflecting mirrors 8, 9, and 10 move at a predetermined speed to scan the document D. Further, a sensor 22 is a sensor for detecting the size of the document D.

The printing unit 120 includes a photosensitive drum 11, a primary charging roller 12, a rotary development unit 13, an intermediate transfer belt 14, a transfer roller 15, a cleaner 16. The photosensitive drum 11 is irradiated with laser light emitted from a laser unit 17 based on image data generated by reading the image on the document D, whereby an electrostatic latent image is formed on a surface of the photosensitive drum 11. The primary charging roller 12 uniformly charges the surface of the photosensitive drum 11 before the irradiation with the laser light.

The rotary development unit 13 applies magenta (M) toner, cyan (C) toner, yellow (Y) toner, and black (K) toner to the electrostatic latent image formed on the surface of the photosensitive drum 11 to form a toner image. The toner image formed on the surface of the photosensitive drum 11 is transferred onto the intermediate transfer belt 14, and the toner image on the intermediate transfer belt 14 is transferred onto a sheet S by the transfer roller 15. The cleaner 16 removes toner remaining on the photosensitive drum 11 after the transfer of the toner image.

The rotary development unit 13 employs a rotary development method, includes developing devices 13K, 13Y, 13M, and 13C, and can be rotated by a motor (not illustrated). At the time of forming a monochrome toner image on the photosensitive drum 11, the developing device 13K is rotated and moved to a development position close to the photosensitive drum 11, and the development is performed. At the time of forming a full-color toner image, the rotary development unit 13 is rotated to sequentially locate each of the developing devices 13K, 13Y, 13M, and 13C in the development position, and the development of the respective colors is sequentially performed.

A sheet S onto which the toner image on the intermediate transfer belt 14 is to be transferred is fed from a cassette 18 or a manual sheet feeding tray 20 to a transfer position. A fixing unit 19 is provided downstream of the transfer roller 15 in the direction to convey a sheet s, and fixes the toner image on the conveyed sheet S. The sheet S with the fixed toner image thereon is discharged by a pair of discharging rollers 21 from the MFP 101 to a sheet processing device 50 located downstream in the direction to convey the sheet S.

While the electrophotographic method is described as the printing method of the printing unit 120 in the present exemplary embodiment, the printing method is not limited thereto. For example, the printing method of the printing unit 120 may be an ink jet method or any other printing methods (e.g., thermal transfer method).

The cassette 18 includes four cassettes, and the cassettes can store sheets of the same size or different sizes from one another. Each of the cassettes includes a sensor for detecting the size of stored sheets based on the position of a guide, and also includes a sensor for detecting the amount of remaining sheets (i.e., whether there is no sheet). The sheets may be stored in a long edge feed (LEF) direction, in which the long sides of the sheets are perpendicular to the direction in which the sheets are conveyed, or may be stored in a short edge feed (SEF) direction, in which the short sides of the sheets are perpendicular to the direction in which the sheets are conveyed.

The sheet processing device 50 is connected to a sheet discharge position of the MFP 101 and is configured to be communicable with the MFP 101 via a signal line (not illustrated). The sheet processing device 50 performs communication with the MFP 101 to operate in cooperation with the MFP 101. The sheet processing device 50 includes staplers 51 and 52. The stapler 51 uses a staple to bind a plurality of sheets S discharged by the pair of discharging rollers 21. The stapler 52 uses no staple to bind a plurality of sheets S discharged by the pair of discharging rollers 21.

The sheet processing device 50 includes a sheet detection sensor 56 configured to detect the presence/absence of a sheet S, and a sheet alignment unit configured to align sheets S. The sheet processing device 50 detects a sheet S conveyed to the sheet alignment unit 57 using the sheet detection sensor 56, and performs binding processing with the stapler 51 or 52 according to a selection made by the user.

Next, a copy function according to the present exemplary embodiment will be described. The user using the MFP 101 can select the copy function from a main menu (not illustrated) displayed on the operation unit 116. The CPU 111 displays a copy setting screen when the user presses a copy function button while the main menu is displayed.

The user can make various copy settings via the setting screen. For example, the user can make settings relating to a double copy function for arranging and printing a plurality of copies of a same image on one side of a single sheet, and/or settings relating to the frame deletion at the time of reading a document. Other than those settings, the user can also make various other settings such as settings of the number of copies to be printed, two-sided printing. The copy settings also include many other setting items that are not described herein as examples. Therefore, it is difficult to make all the settings within one screen. Therefore, the settings of the plurality of functions may be made by shifting a setting screen to a different setting screen for each setting item.

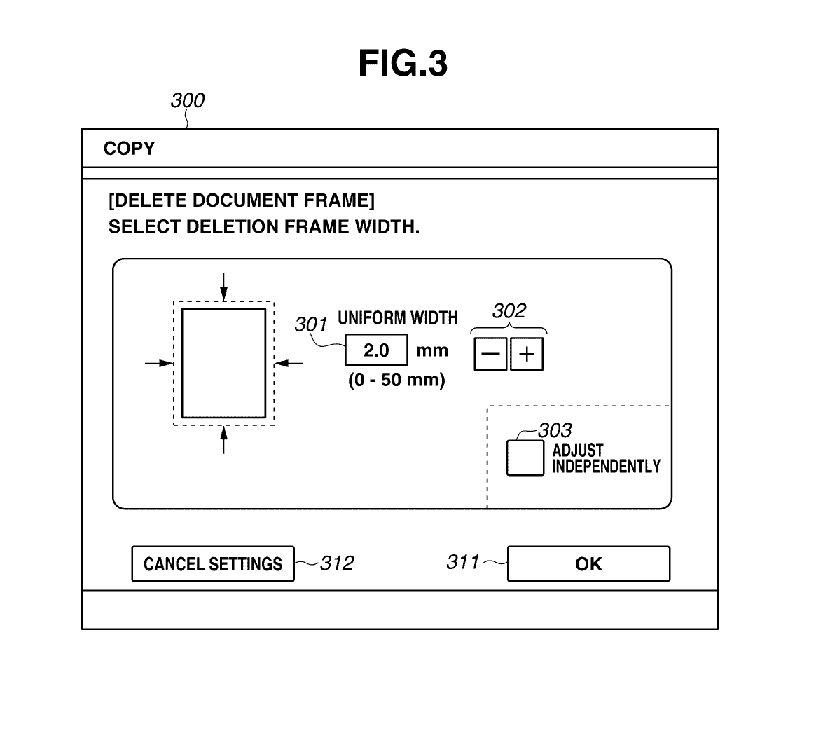

First, the frame deletion function will be described with reference to FIG. 3. FIG. 3 illustrates an example of a setting screen displayed on the operation unit 116, illustrating a setting screen relating to the frame deletion function. The user can make settings for deleting an image in a region of four borders of an image generated by the reading unit 120 via a frame deletion setting screen 300 displayed on the operation unit 116. For example, in a case where the user desires to delete characters added to a header/footer of a fax or shadows of punched holes of a document, the user sets a region from which image data is to be deleted using the frame deletion function. Image data that is read by the reading unit 120 and from which a region of four borders is deleted by the frame deletion function is transmitted to an external apparatus via the network 100 or printed on a sheet.

A field 301 is a field where a currently-set frame width to be deleted is displayed. The user can change the frame width using buttons 302 or number keys (not illustrated). Further, an “adjust independently” key 303 is a key used to set a frame deletion region for each of the four sides of image data independently. At the press of the “adjust independently” key 303, a screen (not illustrated) for setting the frame width to be deleted for each of the four sides of image data independently is displayed. The user can set the frame deletion via the screen for setting the frame width to be deleted independently.

An “OK” key 311 is a key used to apply the settings made via the setting screen 300. At the press of the “OK” key 311, the CPU 111 stores in the RAM 113 the settings relating to the frame deletion that are made via the screen 300. On the other hand, at the press of a “cancel settings” key 312, the CPU 111 cancels the settings made via the screen 300 and returns the screen to the main screen of the copy.

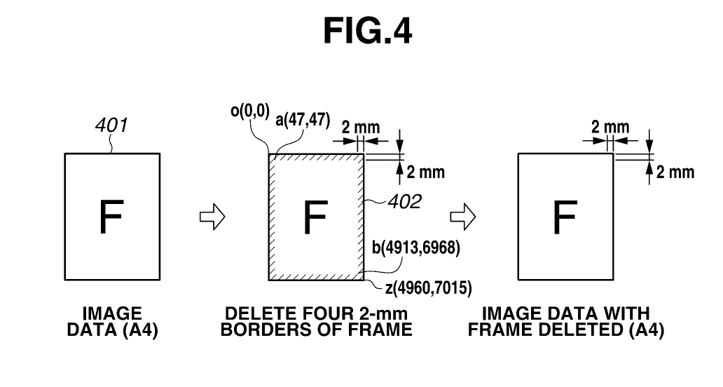

FIG. 4 illustrates a frame deletion function. FIG. 4 illustrates a case where 2 mm from each edge of A4-size (i.e., short side 210 mm and long side 297 mm) image data 401 is deleted as a frame. In the present exemplary embodiment, the frame deletion performed on image data read at a resolution of 600 dpi will be described using coordinates converted into the number of pixels with the top left of the image data as an origin. In the present exemplary embodiment, coordinates o (0, 0) are coordinates that indicate the top left of the image data. Further, coordinates z (width, height) are coordinates that indicate the bottom right of the image data. For example, in a case of A4-size image data, the coordinates z of the bottom right are (4960, 7015).

In a case where the frame deletion of four 2-mm borders is set, a region of 47 pixels from each edge is to be deleted. A region 402 specified by hatching indicates the region of 47 pixels from each edge. The image processing unit 124 performs image processing on the image data 401 to mask with white pixels a portion outside a rectangular region based on coordinates a (47, 47) of a starting point and coordinates b (4913, 6968) of an end point. As a result of this masking processing, image data is acquired in which 47 pixels (i.e., four 2-mm borders) of the four borders of the image data 401 are replaced by white pixels. The image in the four borders of the image data is deleted so that shadows, regions of punched holes, and the like that are produced at the time of the reading can be deleted from the image data.

Next, there is described the control performed to delete an image close to an edge portion at the time of printing an image onto a sheet. In a case of performing non-scaling printing in which an image having the same size as the size of a sheet is printed on the sheet, if the image is printed on an entire surface of the sheet, toner may run off the sheet to cause unintended sheet contamination. Thus, it has been known to set for each edge of a sheet a region (hereinafter, “print-prohibited region”) on which no printing is to be performed.

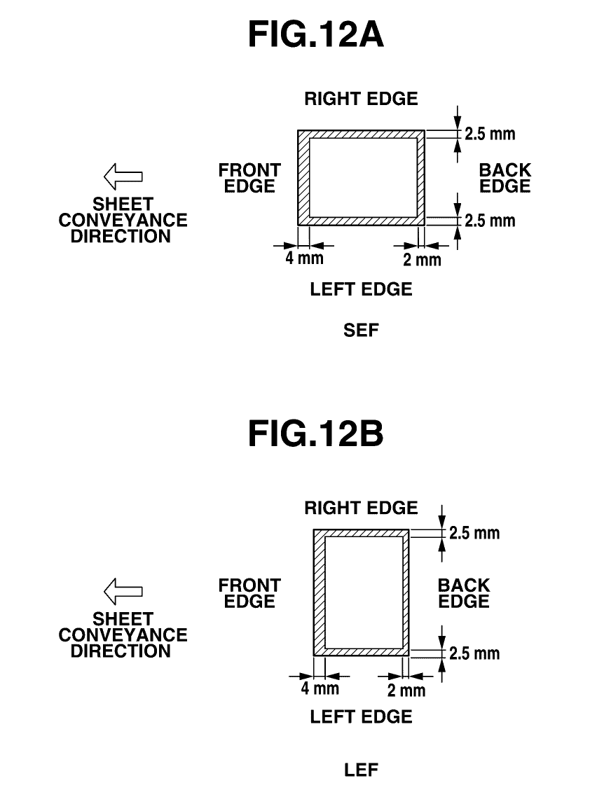

FIGS. 12A and 12B each illustrate a print-prohibited region. FIG. 12A illustrates a print-prohibited region set for a sheet that is to be conveyed in the SEF direction. FIG. 12B illustrates a print-prohibited region set for a sheet that is to be conveyed in the LEF direction. In the present exemplary embodiment, an edge portion of a sheet that is on the downstream side in the direction in which the sheet is conveyed is defined as a front edge of the sheet, and an edge portion of the sheet that is on the upstream side in the direction in which the sheet is conveyed is defined as a back edge of the sheet. Further, an edge portion of the sheet that is on the right side of the sheet when viewed from the back edge of the sheet in the direction in which the sheet is conveyed is defined as a right edge of the sheet, and an edge portion of the sheet that is on the left side of the sheet when viewed from the back edge of the sheet in the direction in which the sheet is conveyed is defined as a left edge of the sheet.

In the printing apparatus according to the present exemplary embodiment, a region of 4 mm from the front edge of the sheet and a region of 2 mm from the back edge of the sheet are set as a print-prohibited region. Further, a region of 2.5 mm from the left edge of the sheet and a region of 2.5 mm from the right edge of the sheet are set as a print-prohibited region. The set values of the print-prohibited regions are stored in the ROM 112 or the storage 114 and referred to as needed in a flow chart described below. The print-prohibited regions can be changed as appropriate according to the capacity of the printing unit 120. Further, different values may be set for the respective print-prohibited regions according to the sheet type such as a thick sheet, normal sheet. Further, different values may be set for the respective print-prohibited regions according to the sheet size.

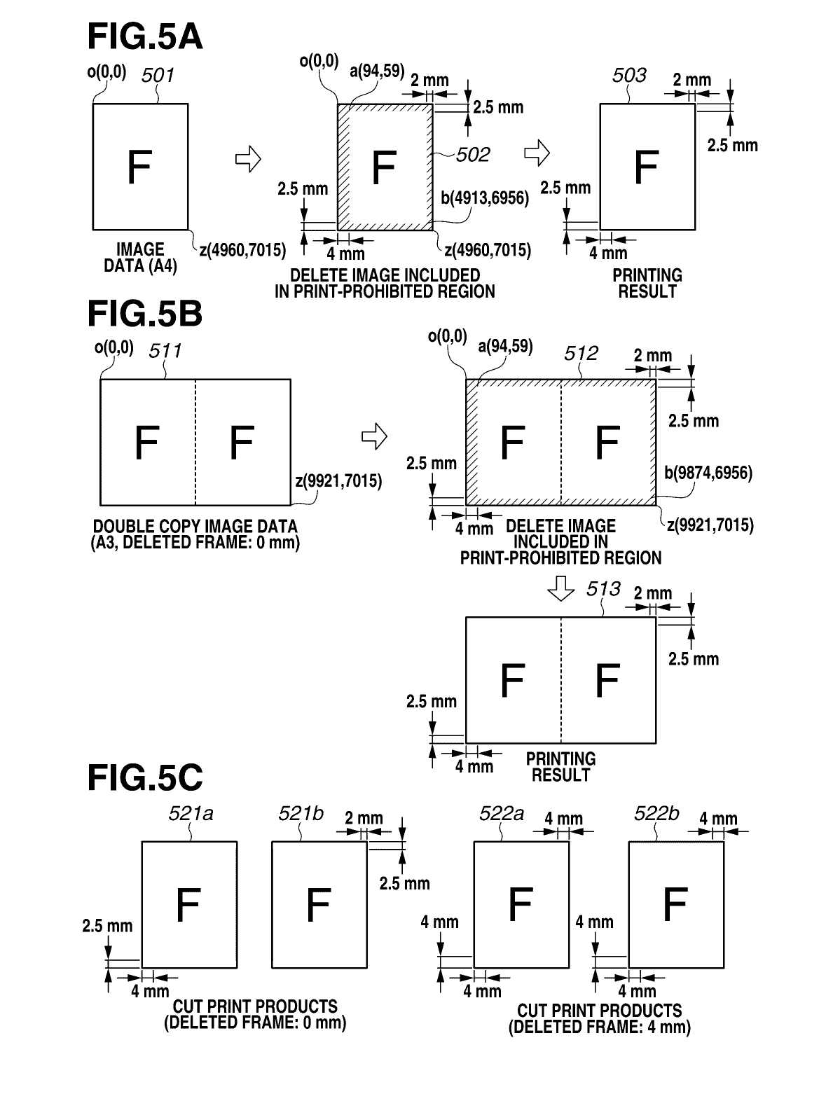

FIGS. 5A, 5B, and 5C each illustrate the image deletion based on the print-prohibited regions. FIG. 5A illustrates an example case of non-scaling printing of an A4-size document onto an A4-size sheet. In the present exemplary embodiment, a case will be described as an example in which an A4-size sheet stored in the LEF direction in the cassette 18 is conveyed to the printing unit 120 and an A4-size image is printed on the sheet. The long side of a print product 503 that is on the left-hand side in FIG. 5A is the front edge at the time of conveying the sheet. Further, image data 501 is image data read at a resolution of 600 dpi by the reading unit 118. Coordinates o (0, 0) specified in FIG. 5A are coordinates that indicate the top left of the image data. Further, coordinates z (4960, 7015) are coordinates that indicate the bottom right of the image data.

In the deletion of the print-prohibited region, pixels to be printed on a region corresponding to 4 mm from the front edge of the sheet and pixels to be printed on a region corresponding to 2 mm from the back edge of the sheet are deleted. Further, an image to be printed on a region corresponding to 2.5 mm from the left edge of the sheet and an image to be printed on a region corresponding to 2.5 mm from the right edge of the sheet are deleted. Accordingly, the print-prohibited region is a region 502 specified by hatching.

The image processing unit 124 performs image processing on the image data 501 to mask with white pixels a portion outside a rectangular region based on coordinates a (94, 59) of a starting point and coordinates b (4913, 6956) of an end point. As a result, image data in which the pixels in the print-prohibited region are deleted from the image data 501 is obtained. The printing unit 120 prints an image on the A4-size sheet based on the image data in which the pixels in the print-prohibited region are deleted. At this time, the portion corresponding to the print-prohibited region in the image data is replaced by the white pixels, so that no toner is applied to the portion at the time of the printing.

As a result of the printing processing, an A4-size print as illustrated as the print product 503 can be obtained. The processing prevents application of toner to the print-prohibited region set for each edge of the sheet, whereby an occurrence of sheet contamination by toner running off the sheet, an occurrence of paper jam by a sheet winding around a roller, and other troubles can be prevented.

Next, the double copy function according to the present exemplary embodiment will be described. In the present exemplary embodiment, the double copy function will be described as an example of the function of arranging and printing a plurality of images on one side of a single sheet. The double copy function is a function of acquiring a piece of image data by reading a document (e.g., A4-size document), and arranging and printing the image data and a copy of the image data (i.e., two pieces of image data) on the same side of a sheet (e.g., A3-size sheet) larger than the original document. In other words, the image is input by reading a document and two duplicates of the input image are arranged at different areas on a single side of a sheet. The user can acquire a plurality of print products of the same size as the size of the document by cutting the printed sheet with a sheet cutting machine or a cutter.

Use of the double copy function can reduce the printing costs, compared to a case where a document is copied onto sheets having the same size as the size of the document. Further, two print products can be obtained by a series of printing processing (i.e., sheet conveyance, image formation, and discharge to a tray) on a single sheet. As a result, compared to a case where a document is copied onto sheets having the same size as the size of the document, the time required for the printing onto a plurality of sheets can be reduced because an operation of keeping a space between the sheets at the time of conveying the sheets becomes unnecessary.

Meanwhile, the deletion of an image in a print-prohibited region may be performed also in the case where printing based on the double copy function is performed. FIGS. 5B and 5C each illustrate the deletion of an image in a print-prohibited region in a case where printing based on the double copy function is performed. In the present exemplary embodiment, a case will be described as an example in which an A3-size sheet stored in the SEF direction in the cassette 18 is conveyed to the printing unit 120 and an A3-size image in which two pieces of the same A4-size image data are arranged is printed on the conveyed A3-size sheet. The short side of a print product 513 that is on the left hand side in FIG. 5B is the front edge at the time of conveying the sheet. Image data 511 is A3-size image data in which two pieces of the same A4-size image data read at a resolution of 600 dpi are arranged. Coordinates o (0, 0) are coordinates that indicate the top left of the image data. Further, coordinates z (9921, 7015) are coordinates that indicate the bottom right of the image data. In the deletion of the print-prohibited region, pixels (94 pixels) corresponding to 4 mm from the front edge of the sheet and pixels (47 pixels) corresponding to 2 mm from the back edge of the sheet are deleted. Further, pixels (59 pixels) corresponding to 2.5 mm from the left edge of the sheet and pixels (59 pixels) corresponding to 2.5 mm from the right edge of the sheet are deleted. Accordingly, the print-prohibited region is a region 512 specified by hatching.

The image processing unit 124 performs image processing on the image data 511 to mask with white pixels a portion outside a rectangular region based on coordinates a (94, 59) of a start point and coordinates b (9874, 6956) of an end point. As a result of this masking processing, image data is obtained in which the image in the print-prohibited region of the image data 511 is deleted. The printing unit 120 prints on the A3-size sheet an image based on the image data in which the image in the print-prohibited region is deleted. As a result of the printing processing, an A3-size print illustrated as the print product 513 is obtained on which an image in a neighborhood region of a cutting position is printed.

In the double copy function, it is expected that an A3-size sheet will be cut along the center line (dotted line portion in FIG. 5B). Cutting the output print product 513 along the center line produces a print product 521a, in which a region of the back edge portion of the sheet is not deleted, and a print product 521b, in which a region of the front edge portion of the sheet is not deleted. Accordingly, the print product 521a includes margins at the front, right, and left edges in the direction in which the sheet to be cut is conveyed, but includes no margin at the back edge in the direction in which the sheet to be cut is conveyed. On the other hand, the print product 521b includes margins at the right, left, and back edges in the direction in which the sheet to be cut is conveyed, but includes no margin at the front edge in the direction in which the sheet to be cut is conveyed. Such a copy result may give the user a feeling of strangeness.

Meanwhile, if the user uses the frame deletion function and the double copy function in combination, the appearances of the cut print products can be corrected. More specifically, if the user makes a setting for deleting four 4-mm borders of image data in using the frame deletion function, image data is obtained in which four 4-mm borders of image data obtained by reading a document (e.g., A4-size document) are masked with white pixels. Thus, in the case where the frame deletion function and the double copy function are used in combination, an image in which two pieces of image data with four 4-mm borders deleted are arranged is to be printed on a sheet. In this case, the portion corresponding to the print-prohibited region 512 and neighboring regions of the adjacent pieces of image data are replaced with the white images by the frame deletion function, so that cut print products will have the same appearance as specified by prints 522a and 522b.

However, conventionally, in a case where the frame deletion setting and the double copy setting are to be made by the user to correct the appearances of print products, the user needs to make the settings by shifting between setting screens, which requires a lot of work. Further, if the user does not know about the frame deletion function or does not even known that a region onto which no image is to be printed exists at an edge portion of a sheet, the user may not know how to correct the appearance.

In view of such a situation, in the present exemplary embodiment, a system for deleting an image in a neighborhood region of a cutting position based on a print-prohibited region to correct the appearances of cut print products in the case where the double copy function is set, will be described.

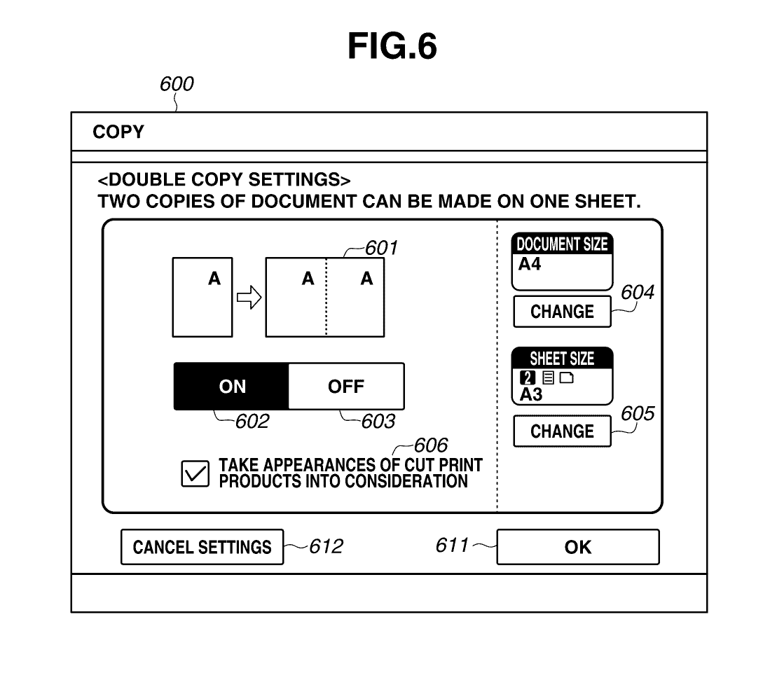

First, the setting of the double copy function according to the present exemplary embodiment will be described with reference to FIG. 6. FIG. 6 illustrates an example of a setting screen displayed on the operation unit 116, displaying a setting screen 600 relating to the double copy function. The screen 600 illustrates an example case where the double copy function is set to be enabled (ON).

An “ON” key 602 is a key used to set the double copy function to be enabled (ON). An “OFF” key 603 is a key used to set the double copy function to be disabled (OFF). The “ON” key 602 and the “OFF” key 603 are mutually exclusive, and only one of the “ON” key 602 and the “OFF” key 603 can be selected. Information 601 illustrates an image of an output result of the double copy.

A check box 606 is a key for setting whether to take the appearances of cut print products into consideration. In the present exemplary embodiment, the setting for taking the appearances of cut print products into consideration is made as a default setting of the screen 600. The default setting for the appearances of cut print products can be changed as needed by an administrator of the MFP 101 or a customer engineer.

In the present exemplary embodiment, whether to perform image processing on a neighborhood region of the cutting position at the time of printing onto a sheet is switched according to whether the box “take the appearances of cut print products into consideration” is checked. In a case where the box “take the appearances of cut print products into consideration” is checked, the image in the neighborhood region of the cutting position is deleted to provide a margin similar to the margins at other edges, and printing processing is executed. On the other hand, in a case where the box “take the appearances of cut print products into consideration” is not checked, the printing processing is executed without deleting the image in the neighborhood region of the cutting position.

A “change” key 604 is a key used to change the size of a document that is a target of the double copy. The user can select the document size such as A4, A5, and B5 by pressing the “change” key 604. The screen 600 illustrates an example case where A4 is selected as the size of the document that is a target of the double copy. The document size may automatically be detected by the sensor 22, for example, provided to the reading unit 118.

Further, a “change” key 605 is a key used to designate a cassette to be used as a sheet feeding source. Cassettes that can be designated using the “change” key 605 are limited as appropriate based on document sizes or sheet sizes stored in association with respective cassettes. For example, in a case where the document size is A4, in order to arrange two pieces of the same image data on a single sheet, an A3-size sheet is needed. Therefore, the cassettes that do not store A3-size sheets are grayed out so that the cassettes cannot be designated. Alternatively, a cassette to be used as a sheet feeding source may be selected automatically based on the document size or the like.

A “cancel settings” key 612 is a key used to cancel the settings made via the screen 600. An “OK” key 611 is a key used to apply the settings made via the screen 600. If the “cancel settings” key 612 is selected, the CPU 111 cancels the settings made via the screen 600 and returns the setting screen to the copy setting screen. On the other hand, if the “OK” key 611 is selected, the CPU 111 temporarily stores in the RAM 113 the settings made via the screen 600 as the copy settings and returns the setting screen to the copy setting screen.

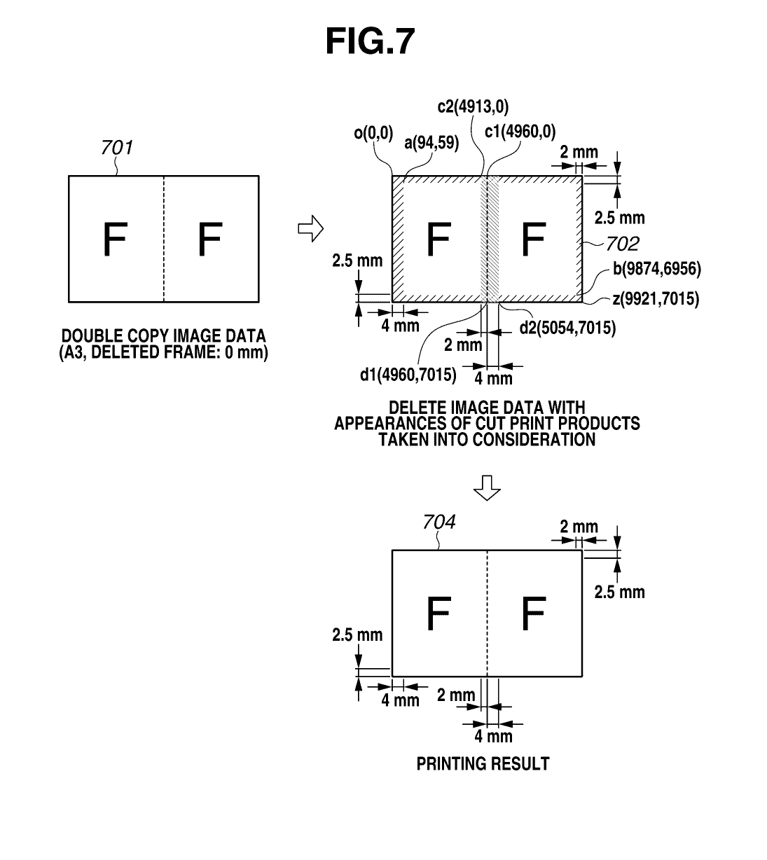

Next, printing processing in a case where the appearances of cut print products are taken into consideration, will be described. FIG. 7 illustrates an example of printing of a case where the appearances of cut print products are taken into consideration according to the present exemplary embodiment. FIG. 7 illustrates an example case where an image based on an A4-size document is double-copied onto an A3-size sheet.

In the present exemplary embodiment, a case will be described as an example in which an A3-size sheet stored in the SEF direction in the cassette 18 is conveyed to the printing unit 120 and an A3-size image in which two pieces of the same A4-size image data are arranged is printed on the sheet. Further, image data 701 is A3-size image data in which two pieces of the same A4-size image data read at a resolution of 600 dpi are arranged along the direction in which the sheet is conveyed. The frame deletion processing has not been performed on the read image data. Coordinates o (0, 0) are coordinates that indicate the top left of the image data. Further, coordinates z (9921, 7015) are coordinates that indicate the bottom right of the image data. In the deletion of a print-prohibited region, pixels (94 pixels) corresponding to 4 mm from the front edge of the sheet and pixels (47 pixels) corresponding to 2 mm from the back edge of the sheet are deleted. Further, pixels (59 pixels) corresponding to 2.5 mm from the left edge of the sheet and pixels (59 pixels) corresponding to 2.5 mm from the right edge of the sheet are deleted. Accordingly, the print-prohibited region is a region 702 specified by hatching.

The image processing unit 124 performs image processing to mask with white pixels an image in the print-prohibited region of the image data 701 as in the processing described above with reference to FIG. 5B. Further, the image processing unit 124 performs image processing to mask with white pixels a neighborhood region of the cutting position. First, coordinates c1 (4960, 0) and d1 (4960, 7015) indicating the position of a border between the arranged two pieces of the image data are calculated based on the coordinates o (0, 0) and z (9921, 7015) of the image data. Further, a rectangular region, which is used in the deletion of an image in a neighborhood region of a line passing through the two points specified by the coordinates c1 and d1, is calculated.

In the present exemplary embodiment, the image deletion processing is executed so that cut print products will have the same appearance. More specifically, pixels (47 pixels) corresponding to 2 mm are deleted from the image adjacent to the border position on the left-hand side of, and pixels (94 pixels) corresponding to 4 mm are deleted from the image adjacent to the border position on the right-hand side. Accordingly, the rectangular region from which the image is to be deleted at the border position between the pieces of image data is a region 703 specified by hatching.

The image processing unit 124 performs image processing to mask with white pixels the inside of the rectangular region based on coordinates c2 (4913, 0) and d2 (5054, 7015). As a result of this processing, image data is obtained in which the images in the regions in the neighborhood of the respective edges of the image data 701 and the image in the neighborhood region of the cutting position are deleted. The printing unit 120 prints an image based on the image data in which the image in the print-prohibited region and the image in the neighborhood region of the cutting position are deleted. As a result of the printing processing, a print product 704 can be obtained in which margin portions of print products obtained by cutting the print product 704 will have the same appearance.

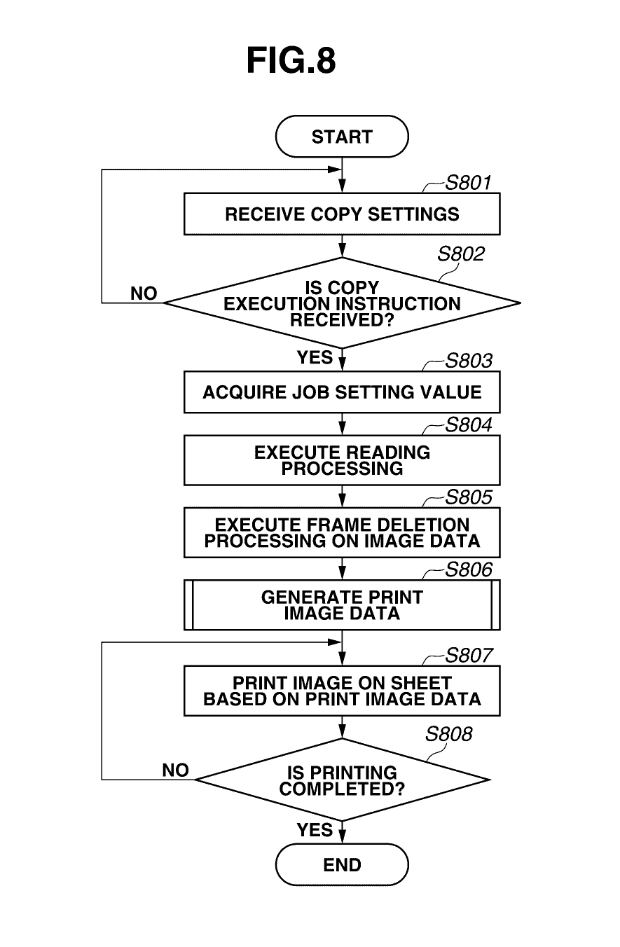

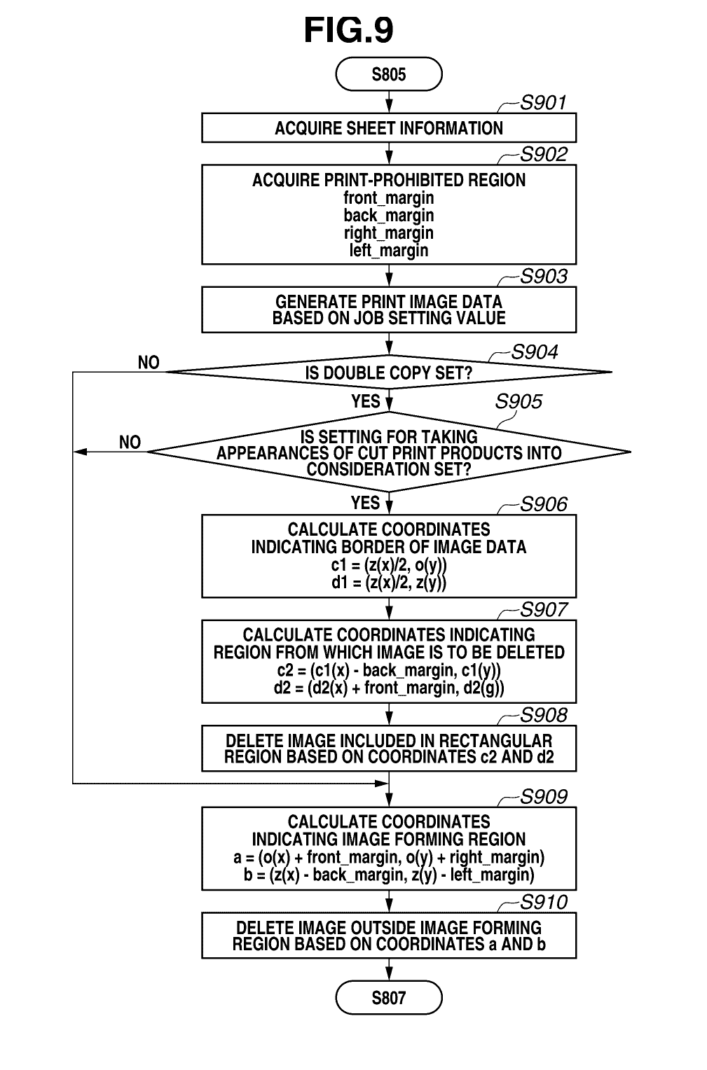

A specific control of the double copy according to the present exemplary embodiment will be described with reference to flow charts illustrated in FIGS. 8 and 9.

FIG. 8 is a flow chart illustrating operations of the MFP 101 starting in response to the selection of the copy function by the user on the menu screen displayed at the time of activation of the MFP 101. The CPU 111 of the MFP 101 executes a control program stored in the ROM 112 or the storage 114 to realize each operation (step) illustrated in the flow charts of FIGS. 8 and 9.

In step S801, the CPU 111 receives a setting relating to the copy and temporarily stores the received setting in the RAM 113. The user can make settings relating to the frame deletion function, the settings relating to the double copy function, and the like described above. In step S802, if a copy execution instruction is received (YES in step S802), the processing proceeds to step S803. On the other hand, if no copy execution instruction is received (NO in step S802), the processing returns to step S801.

In step S803, the CPU 111 acquires a copy job setting value stored temporarily in the RAM 113. In step S804, the CPU 111 cooperates with the reading unit 118 to read an image on a document to generate image data. The number of documents to be read in step S803 may be one or more than one.

In step S805, the CPU 111 cooperates with the image processing unit 124 to perform frame deletion processing on the image data generated in step S804. For example, the CPU 111 refers to the job setting value acquired in step S803, and if the frame deletion of four 2-mm borders is set, the CPU 111 performs frame deletion processing to replace 2 mm from each edge of the image data with a white image. In a case where the frame deletion is not set (i.e., 0 mm), the frame deletion is not performed, and the processing proceeds to step S806.

In step S806, the CPU 111 cooperates with the image processing unit 124 to generate print image data based on the job setting value acquired in step S803 and the image data on which the frame deletion is performed as needed in step S805. A series of processing in step S806 will be described below with reference to the flow chart illustrated in FIG. 9.

In step S807, the CPU 111 cooperates with the printing unit 120 to print an image on a sheet based on the print image data generated in step S806. In step S808, the CPU 111 determines whether the printing of the set number of copies is completed. If the printing of the set number of copies is not completed (NO in step S808), the processing returns to step S807, and the CPU 111 performs printing on a next sheet. On the other hand, if the printing of the set number of copies is completed (YES in step S808), the CPU 111 ends the series of copy processing.

Next, the generation of the print image data will be described with reference to the flow chart illustrated in FIG. 9. In step S901, information about a sheet to be used for the printing is acquired based on the job setting value acquired in step S803. In step S902, the print-prohibited region stored in the RAM 113 or the storage 114 is acquired. For the convenience of the descriptions of step S903 and subsequent steps, the number of pixels from the front edge of the sheet that are not to be printed on the sheet will be referred to as front_margin. Further, the number of pixels from the back edge of the sheet that are not to be printed on the sheet will be referred to as back_margin. Further, the number of pixels from the right edge of the sheet that are not to be printed on the sheet will be referred to as right_margin. Further, the number of pixels from the left edge of the sheet that are not to be printed on the sheet will be referred to as left_margin.

In step S903, the CPU 111 generates a print image based on the job setting value acquired in step S803. More specifically, in a case where the double copy function is set, the CPU 111 cooperates with the image processing unit 124 to generate print image data in which two pieces of the image data generated in steps S804 and S805 are arranged. Further, if the image data generated in steps S804 and S805 needs to be rotated according to the orientation of the sheet to be used for the printing, image data rotation processing is performed to generate print image data for use in the printing.

Next, in step S904, the CPU 111 determines whether the double copy is set for the copy job based on the job setting value. If the double copy is set (YES in step S904), the processing proceeds to step S905. On the other hand, if the double copy is not set (NO in step S904), steps S905 to S908 are skipped, and the processing proceeds to step S909.

In step S905, the CPU 111 determines whether the setting for taking the appearances of cut print products into consideration is made based on the job setting value. If the CPU 111 determines that the setting for taking the appearances of cut print products into consideration is made as a setting relating to the double copy (YES in step S905), the processing proceeds to step S906. On the other hand, if the CPU 111 determines that the setting for taking the appearances of cut print products into consideration is not made (NO in step S905), the processing proceeds to step S909.

In step S906, the CPU 111 calculates the coordinates c1 and d1 indicating the border position between the two pieces of the image data. For example, in a case of printing on a sheet stored in the SEF direction in the cassette 18, the center in the x-direction is the border position. Accordingly, the coordinates c1 are (z(x)/2, o(y)), and the coordinates d1 are (z(x)/2, z(y)).

In step S907, the CPU 111 calculates the coordinates c2 of the start point and the coordinates d2 of the end point of the rectangular region from which the image in the neighborhood of the border between the two pieces of the image data is to be deleted. The coordinates c2 of the start point are coordinates that are shifted in the x-direction by “−back_margin” from the coordinates c1 calculated in step S906. The coordinates d2 of the end point are coordinates that are shifted in the x-direction by “front_margin” from the coordinates d1 calculated in step S906.

In step S908, the image in the rectangular region based on the coordinates c2 and d2 is deleted. The CPU 111 overwrites pixels in the rectangular region with white pixels, and the processing proceeds to step S909.

By the processing from steps S906 to S908, the image in the neighborhood of the border position between the two pieces of the image data can be deleted. At this time, an image corresponding to the same number of pixels as “back_margin” is deleted from the image adjacent to the border position on the left-hand side. Further, an image corresponding to the same number of pixels as “front_margin” is deleted from the image adjacent to the border position on the right-hand side.

In step S909, the CPU 111 calculates coordinates a and b indicating an image forming region based on the print-prohibited region acquired in step S902. The coordinates a are coordinates that are shifted by bot “front_margin” in the x-direction and “right_margin” in the y-direction from the coordinates o (0, 0) of the top left of the print image data. Further, the coordinates b are coordinates that are shifted by “−back_margin” in the x-direction and “−left_margin” in the y-direction from the coordinates z (width, height) of the bottom right of the print image data. The rectangular region based on the coordinates a and b is the image forming region excluding the print-prohibited region.

In step S910, the CPU 111 cooperates with the image processing unit 124 to delete an image outside the image forming region based on the coordinates a and b. If the deletion processing for deleting pixels outside the image forming region is completed, the series of processing is ended, and the processing proceeds to step S807.

As described above, in the present exemplary embodiment, image processing can be performed to delete the image in the neighborhood region of the cutting position based on the size of the print-prohibited region. Thus, cut print products can have the same appearance. Further, in the present exemplary embodiment, whether to correct the appearances of cut print products can be switched according to the intention of the user. Through this processing, not deleting a region of a document can be prioritized over the appearances of prints in a case where the user desires to copy the document without deleting a region of the document if possible.

While the case is described as an example in the present exemplary embodiment in which the image in the region that is to be deleted is changed to white pixels in the image deletion processing performed in steps S908 and S909 to prevent application of a color material (toner) to the region at the time of the printing, however it is not limited thereto. For example, pixel values of the region that is to be deleted may be changed to “NULL” or the like that indicates no color material is to be applied.

Further, for example, when the laser unit 17 generates laser light based on the image data generated in step S903, the CPU 1111 may perform control not to apply the laser light to a position at which image formation is unnecessary, whereby no electrostatic latent image of the region to be deleted is formed. Further, in a case where the printing method of the printing unit 120 is the ink jet method, the CPU 1111 may perform control to discharge no ink when a print head (not illustrated) is located at a position corresponding to a region from which an image is to be deleted, whereby the region to be deleted is deleted. In this case, if the print head is located at a position that does not correspond to the region to be deleted (i.e., a position on which an image is to be printed), the CPU 1111 may perform control to discharge ink, and execute the printing based on the image.

### OTHER EXEMPLARY EMBODIMENTS

### First Modified Example

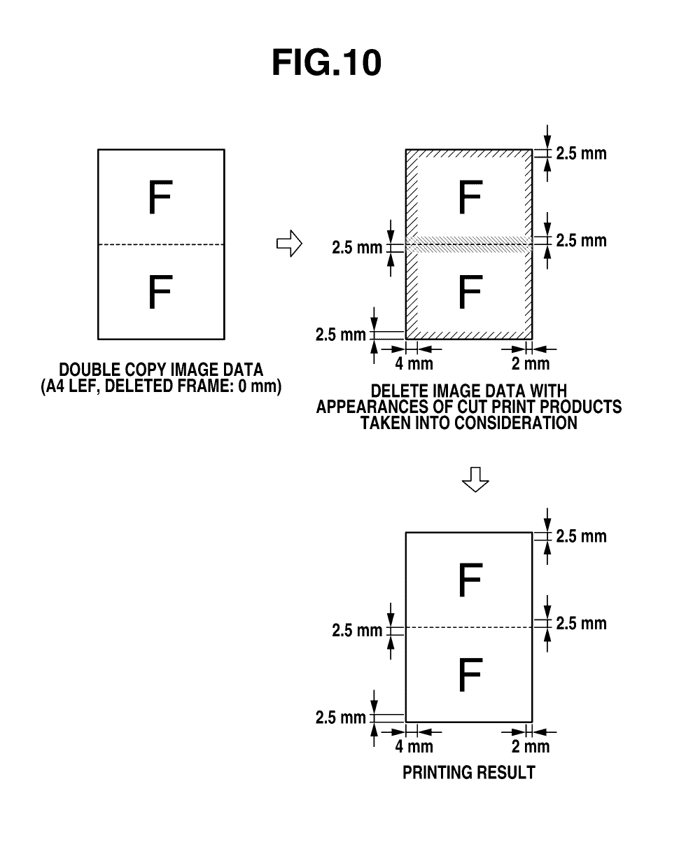

While the case is described as an example in the first exemplary embodiment in which a print image generated by arranging two same images along the direction to convey a sheet is printed on the sheet conveyed in the SEF direction, however, it is not limited thereto. For example, an exemplary embodiment of the present invention is also applicable to a case where a print image generated by arranging two same images along a direction orthogonal to the direction to convey a sheet is printed on the sheet conveyed in the LEF direction. For example, in a case of double copying an A5-size document on an A4-size sheet conveyed in the LEF direction, the image deletion processing as illustrated in FIG. 10 needs to be performed. In this case, the direction of the border between the two pieces of the image data calculated in step S906 is the center in the y-axis direction. Further, the region from which the image is to be deleted, which is calculated in step S907, is determined based on “right_margin” and “left_margin”, which are regions of the sheet edge portions parallel to the border line of the image data.

### Second Modified Example

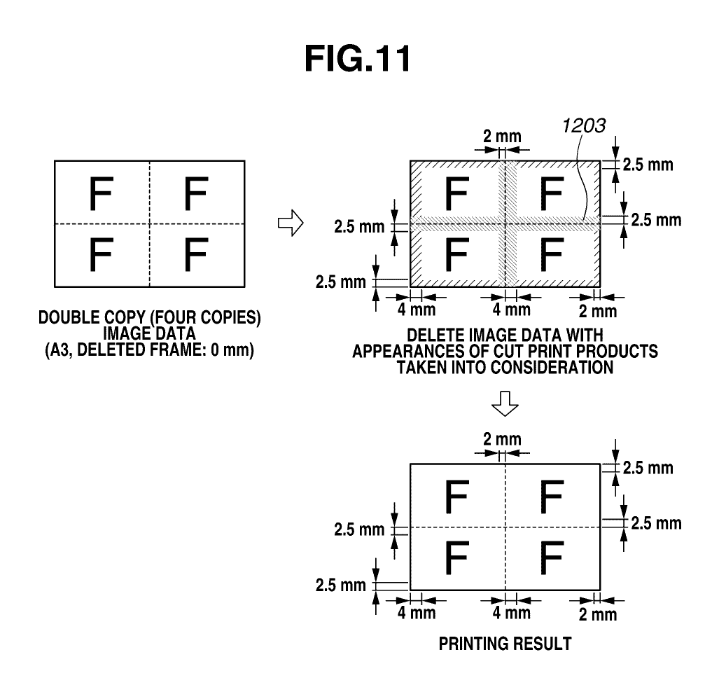

While the case is described as an example in the first exemplary embodiment in which two images are arranged and printed on one side of a single sheet, however, it is not thereto. For example, an exemplary embodiment of the present invention is also applicable to a case where a plurality of images is arranged and printed along each of the direction to convey the sheet and a direction orthogonal to the direction to convey a sheet, as illustrated in FIG. 11. In this case, a region (region 1203) of borders between adjacent images may be deleted so that cut sheets will have the same appearance. While the case is described as an example in the second modified example in which the plurality of images is arranged along each of the direction to convey the sheet and the direction orthogonal to the direction to convey the sheet, and printed on the sheet conveyed in the SEF direction, however, it is not limited thereto. An exemplary embodiment of the present invention is also applicable to a case where a plurality of images is arranged along each of the direction to convey the sheet and the direction orthogonal to the direction to convey the sheet, and printed on the sheet conveyed in the LEF direction.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-182153, filed Sep. 15, 2015, which is hereby incorporated by reference herein in its entirety.

What is claimed is:

1. A printing apparatus capable of arranging a plurality of duplicates of an input image on a same side of a single sheet, the printing apparatus comprising:
a printing unit configured to print an image on a sheet using a color material; and
a controller configured to act as:
a changing unit configured to change, to a white image, a portion of an image to be printed by the printing unit, based on a region provided at each edge of the sheet and to which the color material is not to be applied; and
a control unit configured to control the changing unit to change, to a white pixel, a neighborhood of a border between the plurality duplicates arranged on the same side of the single sheet, based on a size of the region to which the color material is not to be applied.

2. The printing apparatus according to claim 1, wherein the controller is further configured to act as a setting unit configured to set whether to take an appearance of a cut print product into consideration in a case where a plurality of duplicates are arranged and printed on a same side of a single sheet,
wherein the control unit controls, in a case where a setting for taking an appearance of a cut print product into consideration is not made by the setting unit, the changing unit not to change, to white pixels, the neighborhood of the border between the plurality duplicates arranged on the same side even in the case where the plurality of duplicates are arranged and printed.

3. The printing apparatus according to claim 1, wherein the control unit controls, in a case where two duplicates of the input image are arranged and printed on a same side of a single sheet along a direction in which the sheet is conveyed, the changing unit to change, to white pixels, a neighborhood of a border between the two duplicates based on a width of a region provided at each of a front edge and a back edge of the sheet, and to which the color material is not to be applied.

4. The printing apparatus according to claim 3, wherein the control unit controls the changing unit to change, to white pixels, a portion, of one of the two duplicates, on a downstream side in the direction in which the sheet is conveyed, based on a width of the region provided at the back edge of the sheet and to which the color material is not to be applied, and a portion, of one of the two duplicates, on an upstream side in the direction in which the sheet is conveyed, based on a width of the region provided at the front edge of the sheet and to which the color material is not to be applied.

5. The printing apparatus according to claim 1, further comprising:
a reading unit configured to read a document and generate an image; and
wherein the controller is further configured to act as a generation unit configured to generate an image for printing in which a plurality of copies of the image that is read by the reading unit is arranged,
wherein the changing unit changes, to a white image, a portion of the image for printing generated by the generation unit.

6. A method of arranging and printing a first duplicate and a second duplicate of an input image on a first area and a second area, respectively, on a same side of a single sheet, the first area corresponding to a front edge side of the sheet and the second area corresponding to a back edge side of the sheet, the method comprising:
masking parts of the first duplicate and the second duplicate so that a color material is not applied to the parts; and
printing the masked first duplicate and the masked second duplicate on the sheet using the color material,
wherein, in the masking, a first part of the first duplicate on the front edge side is masked, a second part of the second duplicate on the back edge side is masked, and a size of the second part is different from a size of the first part, a third part of the first duplicate on the back edge side is masked, and a size of the third part corresponds to the size of the second part, a fourth part of the second duplicate on the front edge side, and a size of the fourth part is based on the size of the first part.

7. The method according to claim 6, wherein the first part is larger than the second part.

8. The method according to claim 6, wherein the input image is an image of a single sheet of a document read by a reader.

9. The method according to claim 6, further comprising performing frame deletion processing prior to the masking to delete a region of four sides of the image by a size set by a user,
wherein in the masking, the first, second, third, and fourth parts are masked based on a size set separately from the set size.
